(19) United States
(12) Patent Application Publication
(10) Pub. No.: US 2007/0134445 A1
(43) Pub. Date: Jun. 14, 2007

(54) PVA-FREE HYDROUS GLUE FOR POLARIZING FILMS WITH IMPROVED RESISTANCE TO HEAT AND MOISTURE

(76) Inventor: Cheng-Hsin Tsai, Tao-Yuan City (TW)

Correspondence Address: NORTH AMERICA INTELLECTUAL PROPERTY CORPORATION, P.O. BOX 506, MERRIFIELD, VA, 22116, US

(21) Appl. No.: 11/306,855

(22) Filed: Jan. 13, 2006

(30) Foreign Application Priority Data
Dec. 9, 2005 (TW) 094143498

(51) Int. Cl. G02B 5/30

(52) U.S. Cl. 428/1.31

(57) ABSTRACT

PVA-free hydrous glue for adhering a PVA film to a TAC film of a polarizing film is disclosed. The ingredients of the PVA-free hydrous glue include water, dicarboxylic acid, protonic acid, Lewis acid, and masking agent. The resultant polarizing film formed by employing the PVA-free hydrous glue has improved resistance to heat and moisture. Besides, the present invention PVA-free hydrous glue is easier to prepare and is more stable.

### BACKGROUND OF THE INVENTION

1. Field of the Invention

The present invention relates to the preparation and composition of hydrous glue and, more particularly, to the preparation and composition of PVA-free hydrous glue suited for polarizing sheets with improved resistance to heat and moisture.

2. Description of the Prior Art

Films based on polyvinyl alcohol (PVA) containing iodine or dichroic dyestuffs as polarizing agents are known in the art. Polarizers or polarizing sheets based on PVA dyed with iodine have high polarization characteristics and are widely used in production of liquid-crystal display devices for cell phones, watches, calculators, personal computers, monitors, electronic clocks, word-processors, automobiles, liquid crystal televisions, etc. Besides, more and more LCD devices are now used in relatively severer environments such as, for example, outdoors commercial displays, in-car GPS screens, navigation systems of vehicles, or satellites. The market demand for polarizing sheets with high polarization performance has increased along with the use of such liquid-crystal display devices.

FIG. 1 is a schematic, cross-sectional diagram demonstrating a polarizing sheet 10 according to the prior art. Typically, the polarizing sheet 10 includes an adhesive release film 12, a pressure-sensitive adhesive film 14, a polyvinyl alcohol (PVA) film 18 sandwiched between triacetyl cellulose (TAC) films 16 and 20, and a protective film 22 laminated on the TAC film 20. In other cases, an anti-glare coating, an anti-reflection coating or hard-coating film may be employed on the TAC film 20. The iodine-type polarizing sheet is more prevalent in the industry than other types because of its high optical performance and because it is cheaper.

Generally, an iodine-type polarizing sheet is produced by lamination of TAC films 16 and 20 on both sides of the PVA film 18. Prior to the lamination, the PVA film 18 undergoes pre-treatment such as swelling, dyeing, and re-stretching. The pre-treated PVA film 18 is laminated with the TAC films 16 and 20, which are also pre-treated with alkaline solution such as sodium hydroxide or potassium hydroxide, by applying previously prepared hydrogel adhesive containing dissolved PVA powders therein.

However, the preparation of the aforesaid hydrogel adhesive containing dissolved PVA powders is troublesome and time-consuming. To dissolve PVA powders, a great deal of time (at least 3-4 hours) and vigorous stirring are usually required. While stirring, the solution is heated at 80-90° C. to dissolve PVA powders. Besides, the PVA-containing hydrogel adhesive of prior arts has to be used in one or two days because of poor stability and aggregation may occur. It is desired to reduce the time required to prepare the aforesaid adhesive for adhering PVA and TAC films and to increase its stability such that the adhesive can be preserved longer.

Another drawback of the iodine-type polarizing sheet in prior arts is that its resistance to heat and moisture is not satisfactory. In some severe environments, the adsorbed molecular iodine decays due to its volatile nature, thus adversely affecting its optical performance. From this aspect, it is desired to improve both the optical performance and durability of the polarizing sheet such that the polarizing sheet can withstand severe environments.

### SUMMARY OF THE INVENTION

It is one object of the present invention to provide a composition of PVA-free hydrous glue suited for polarizing sheets with improved resistance to heat and moisture.

According to the claimed invention, a polyvinyl alcohol (PVA)-free hydrous glue composition for adhering a PVA polarizing film to an alkaline-treated triacetyl cellulose (TAC) support film is disclosed. The PVA-free hydrous glue composition includes water; at least one dicarboxylic acid monomer that is dissolvable in said water, wherein said dicarboxylic acid monomer reacts with hydroxyl groups on respective surfaces of said PVA polarizing film and said TAC support film through esterification reaction to form a chemical bonding structure; protonic acid for catalyzing said esterification reaction; Lewis acid; and a masking agent that reacts with said respective surfaces of said PVA polarizing film and said TAC support film, thereby forming a hemi-acetal chemical bonding structure to provide steric hindrance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a schematic, cross-sectional diagram demonstrating a polarizing sheet according to the prior art;

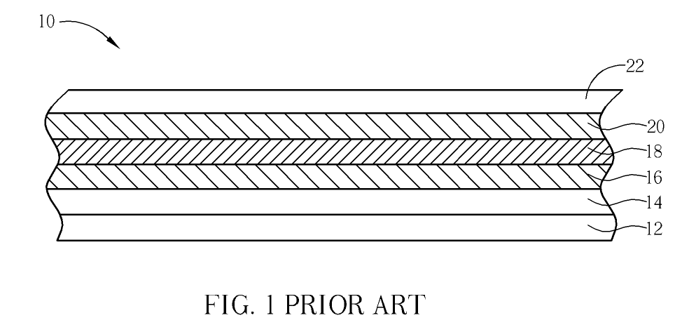

FIG. 2 demonstrates the structural formula of adipic acid; and

FIG. 3 is a schematic, exaggeratedly enlarged diagram demonstrating the interface between an alkaline-treated TAC film and a PVA polarizing film during lamination with acid-catalyzed hydrous glue containing adipic acid in accordance with the preferred embodiment of the present invention.

### DETAILED DESCRIPTION

The present invention pertains to aqueous, polyvinyl alcohol (PVA)-free glue, which excels in fluidity, stability, simplicity of preparation, preservation and resistance to heat and moisture. According to this invention, one key component is dicarboxylic acid, which acts as a “linker” between two respective surfaces of PVA and triacetyl cellulose (TAC) films, on which hydroxyl groups present.

The preparation of the PVA-containing aqueous hydrogel is tedious and time-consuming. There is a strong need to improve the stability and adhesive ability of the prior art PVA-containing aqueous hydrogel.

The present invention provides a composition of hydrous glue, which is capable of reducing the time required to prepare the glue for the polarizing sheets as comparing the prior art PVA-containing hydrogel. One salient feature of the present invention is that the conventional PVA polymer powder is replaced with adipic acid monomer (HOOCC₄H₈COOH) that is dissolvable in water. Accordingly, the hydrous glue of this invention is PVA-free glue. The advantages of this invention at least comprise much simplified manufacturing process and better productivity.

The process for the preparation of such PVA-free hydrous glue is simplified. Because the PVA-free glue of this invention is not gel-type glue, aggregation will not occur and stability is improved. Hence, the PVA-free glue of this invention can be preserved longer.

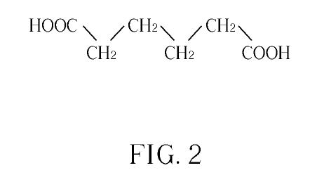

As mentioned, the dicarboxylic acid is employed as a key component for the preparation of PVA-free hydrous glue of this invention. According to the preferred embodiment, adipic acid monomer, which is a known starting material for manufacturing Nylon™, is used. The structural formula of adipic acid is illustrated in FIG. 2. As shown in FIG. 2, each adipic acid has two carboxyl groups at its two ends.

In accordance with one preferred embodiment of this invention, the composition of the PVA-free hydrous glue comprises water, adipic acid, at least one strong protonic acid, and catalytic agent. The strong protonic acid may be hydrochloric acid, sulfuric acid or nitric acid.

In accordance with another preferred embodiment of this invention, the composition of the PVA-free hydrous glue comprises water, adipic acid, hydrochloric acid, catalytic agent, and masking agent. It is noted that the adipic acid may be replaced with other suitable dicarboxylic acids such as glutaric acid or succinic acid.

The aforesaid catalytic agent comprises inorganic metal salts such as zinc chloride (ZnCl₂), aluminum chloride (AlCl₃) or the like, preferably, zinc chloride. Zinc chloride, which is a Lewis acid (an electrophile or electron acceptor), finds wide application in other fields such as textile processing, metallurgical fluxes and chemical synthesis.

In accordance with another preferred embodiment of this invention, the aforesaid catalytic agent may be metal oxide compounds such as, for example, zinc oxide (ZnO) or aluminum oxide (Al₂O₃).

The masking agent may comprise dialdehyde such as glyoxal or methylglyoxal, preferably, glyoxal. Glyoxal is commercially available as a solution in water (40%) or as a hydrate. Methylglyoxal, also called pyruvaldehyde (C₃H₄O₂) is the aldehyde form of pyruvic acid.

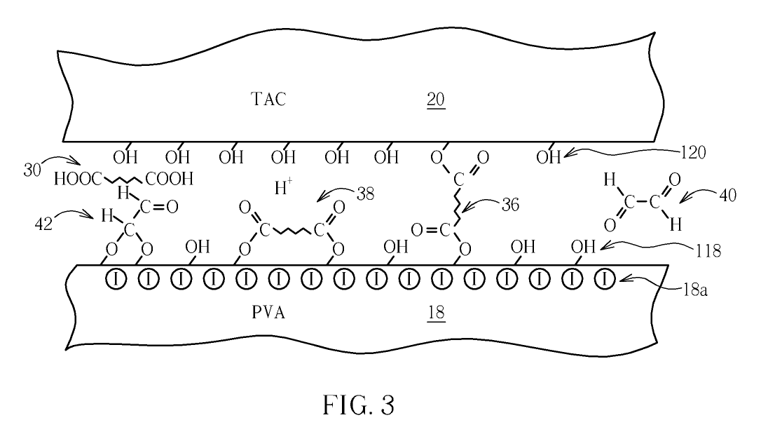

Please refer to FIG. 3. FIG. 3 is a schematic, exaggeratedly enlarged diagram demonstrating the interface between an alkaline-treated TAC film 20 and a PVA polarizing film 18 during lamination with acid-catalyzed hydrous glue containing adipic acid in accordance with the preferred embodiment of the present invention. According to this invention, the PVA polarizing film 18 is pre-treated by using conventional processes such as swelling, iodine dyeing, and stretching, such that the PVA polarizing film 18 adsorbs iodine 18a therein.

As shown in FIG. 3, hydroxyl groups 118 and 120 are provided on the surface of the PVA polarizing film 18 and on the surface of the TAC support film 20, respectively. The hydroxyl groups 118 and 120 react with the carboxyl groups of adipic acid 30 of the applied hydrous glue, thus producing chemical bonding structure 36 that bonds the two surfaces of the PVA polarizing film 18 and the TAC support film 20. This reaction is also referred to as esterification.

However, single surface reaction may occur, that is, both of the carboxyl groups at two ends of the adipic acid 30 may react with hydroxyl groups 118 on one surface of the PVA polarizing film 18 to form ineffective chemical bond structure 38, as depicted in FIG. 3, or both of the carboxyl groups at two ends of the adipic acid 30 may react with hydroxyl groups 120 on one surface of the TAC support film 20, which is not explicitly shown. Such single surface reaction (or referred to as competition reaction) does not help to form strong bonding between the two surfaces of the PVA polarizing film 18 and the TAC support film 20. To prevent this, the masking agent, glyoxal 40, is added into the hydrous glue. The glyoxal 40 can react with the hydroxyl groups 118 on one surface of the PVA polarizing film 18 to form semi-acetal chemical bonding structure 42 and provide steric hindrance to avoid the aforesaid single surface reaction of the adipic acid, such that most of the adipic acid molecules 30 can react with two surfaces (double surface reaction) and form effective bonding.

To more explain the features and advantages of the glue composition of the present invention, several preferred examples and three comparison examples are demonstrated. It is noted that the components used in these examples are high-purity with optical scale, and are available from suitable chemical vendors.

### FIRST PREFERRED EXAMPLE

Weighted adipic acid monomer was dissolved in 50° C.-60° C. hot water and stirred, making an adipic acid aqueous solution having a concentration of about 1-10 wt. %. Afterwards, three components including hydrochloride acid, zinc chloride and glyoxal were added into the aforesaid aqueous solution, wherein the concentration of hydrochloride acid in the solution ranges between 0.1 M and 1.0 M, the concentration of glyoxal in the solution ranges between 3-10 wt. %, and the concentration of zinc chloride in the solution ranges between 1-10 wt. %. After careful stirring and heating for about ten minutes, clear and colorless glue was obtained.

### SECOND PREFERRED EXAMPLE

Weighted glutaric acid monomer was dissolved in 50° C.-60° C. hot water and stirred, making a glutaric acid aqueous solution having a concentration of about 1-10 wt. %. Afterwards, three components including hydrochloride acid, zinc chloride and glyoxal were added into the aforesaid aqueous solution, wherein the concentration of hydrochloride acid in the solution ranges between 0.1 M and 1.0 M, the concentration of glyoxal in the solution ranges between 3-10 wt. %, and the concentration of zinc chloride in the solution ranges between 1-10 wt. %. After careful stirring and heating for about ten minutes, clear and colorless glue was obtained.

### THIRD PREFERRED EXAMPLE

Weighted succinic acid monomer was dissolved in 50° C.-60° C. hot water and stirred, making a succinic acid aqueous solution having a concentration of about 1-10 wt. %. Afterwards, three components including hydrochloride acid, zinc chloride and glyoxal were added into the aforesaid aqueous solution, wherein the concentration of hydrochloride acid in the solution ranges between 0.1 M and 1.0 M, the concentration of glyoxal in the solution ranges between 3-10 wt. %, and the concentration of zinc chloride in the solution ranges between 1-10 wt. %. After careful stirring and heating for about ten minutes, clear and colorless glue was obtained.

### FOURTH PREFERRED EXAMPLE

Weighted adipic acid monomer was dissolved in 50° C.-60° C. hot water and stirred, making an adipic acid aqueous solution having a concentration of about 1-10 wt. %. Afterwards, three components including hydrochloride acid, aluminum chloride (AlCl₃) and glyoxal (masking agent) were added into the aforesaid aqueous solution, wherein the concentration of hydrochloride acid in the solution ranges between 0.1 M and 1.0 M, the concentration of glyoxal in the solution ranges between 3-10 wt. %, and the concentration of aluminum chloride in the solution ranges between 1-10 wt. %. After careful stirring and heating for about ten minutes, clear and colorless glue was obtained.

### FIFTH PREFERRED EXAMPLE

Weighted glutaric acid monomer was dissolved in 50° C.-60° C. hot water and stirred, making a glutaric acid aqueous solution having a concentration of about 1-10 wt. %. Afterwards, three components including hydrochloride acid, aluminum chloride (AlCl₃) and glyoxal (masking agent) were added into the aforesaid aqueous solution, wherein the concentration of hydrochloride acid in the solution ranges between 0.1 M and 1.0 M, the concentration of glyoxal in the solution ranges between 3-10 wt. %, and the concentration of aluminum chloride in the solution ranges between 1-10 wt. %. After careful stirring and heating for about ten minutes, clear and colorless glue was obtained.

### SIXTH PREFERRED EXAMPLE

Weighted succinic acid monomer was dissolved in 50° C.-60° C. hot water and stirred, making a succinic acid aqueous solution having a concentration of about 1-10 wt. %. Afterwards, three components including hydrochloride acid, aluminum chloride (AlCl₃) and glyoxal (masking agent) were added into the aforesaid aqueous solution, wherein the concentration of hydrochloride acid in the solution ranges between 0.1 M and 1.0 M, the concentration of glyoxal in the solution ranges between 3-10 wt. %, and the concentration of aluminum chloride in the solution ranges between 1-10 wt. %. After careful stirring and heating for about ten minutes, clear and colorless glue was obtained.

### FIRST COMPARISON EXAMPLE

### PVA Hydrogel-1

Weighted PVA powders were dissolved in hot water, heated and stirred vigorously in order to prevent aggregation. The solution was then cooled down to room temperature under stirring conditions. Vaporized water is refilled and the solution was filtered to remove small aggregates, yielding a hydrogel with 5% PVA content. The time required for preparation was typically several hours.

### SECOND COMPARISON EXAMPLE

### PVA Hydrogel-2

Weighted PVA powders were dissolved in hot water, heated and stirred vigorously in order to prevent aggregation. The solution was then cooled down to room temperature, and boric acid and zinc chloride were added under stirring conditions. Vaporized water is refilled and the mixture solution was filtered to remove small aggregates, yielding a hydrogel with 5% PVA content.

### THIRD COMPARISON EXAMPLE

### PVA Hydrogel-3

Weighted PVA powders were dissolved in hot water, heated and stirred vigorously in order to prevent aggregation. The solution was then cooled down to room temperature, and hydrochloric acid, glyoxal and zinc chloride were added under stirring conditions. Vaporized water is refilled and the mixture solution was filtered to remove small aggregates, yielding a hydrogel with 5% PVA content. The time required for preparation was typically several hours.

The resistance test to heat and moisture of TAC-PVA-TAC films formed by utilizing the above exemplary glue samples is performed in term of time of peeling. In order to monitor the resistance to heat and moisture, the produced TAC-PVA-TAC films are exposed to severe environmental conditions. The TAC-PVA-TAC films were immersed in 50° C. hot water bath. According to the test results, it has been found that the TAC-PVA-TAC films formed by utilizing glue samples containing Lewis acid zinc chloride (set forth in the above first to third preferred examples) has higher resistance to heat and moisture than those utilizing glue samples containing aluminum chloride (set forth in the above fourth to sixth preferred examples). It has been found that the TAC-PVA-TAC films formed by utilizing PVA-free hydrous glue samples (first to sixth preferred examples) have higher resistance to heat and moisture than those utilizing PVA hydrogel (first to third comparison examples). According to the test results, the time of peeling for the TAC-PVA-TAC films utilizing glue samples containing Lewis acid zinc chloride is three days, while in the same testing environments, the time of peeling for the TAC-PVA-TAC films utilizing PVA hydrogel (first to third comparison examples) is less than 50 minutes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A polyvinyl alcohol (PVA)-free hydrous glue composition for polarizing films, comprising water; at least one dicarboxylic acid monomer that is dissolvable in said water; protonic acid; and Lewis acid.

2. The PVA-free hydrous glue composition for polarizing films according to claim 1, wherein said dicarboxylic acid monomer comprises adipic acid, glutaric acid and succinic acid.

3. The PVA-free hydrous glue composition for polarizing films according to claim 2, wherein said dicarboxylic acid monomer has a concentration of about 1-10 wt. %.

4. The PVA-free hydrous glue composition for polarizing films according to claim 1, wherein said protonic acid comprises hydrochloric acid, sulfuric acid and nitric acid.

5. The PVA-free hydrous glue composition for polarizing films according to claim 4, wherein said protonic acid has a concentration of 0.1 M to 1.0 M.

6. The PVA-free hydrous glue composition for polarizing films according to claim 1, wherein said Lewis acid comprises zinc chloride and aluminum chloride.

7. The PVA-free hydrous glue composition for polarizing films according to claim 6, wherein said Lewis acid has a concentration of about 1-10 wt. %.

8. The PVA-free hydrous glue composition for polarizing films according to claim 1 further comprising a masking agent, wherein said masking agent is dialdehyde compound.

9. The PVA-free hydrous glue composition for polarizing films according to claim 8, wherein said dialdehyde compound comprises glyoxal and methylglyoxal.

10. The PVA-free hydrous glue composition for polarizing films according to claim 8, wherein said masking agent has a concentration of about 3-10 wt. %.

11. A polyvinyl alcohol (PVA)-free hydrous glue composition for adhering a PVA polarizing film to an alkaline-treated triacetyl cellulose (TAC) support film, comprising:
water;
at least one dicarboxylic acid monomer that is dissolvable in said water, wherein said dicarboxylic acid monomer reacts with hydroxyl groups on respective surfaces of said PVA polarizing film and said TAC support film through esterification reaction to form a chemical bonding structure;
protonic acid for catalyzing said esterification reaction;
Lewis acid; and
a masking agent that reacts with said respective surfaces of said PVA polarizing film and said TAC support film, thereby forming a hemi-acetal chemical bonding structure to provide steric hindrance.

12. The PVA-free hydrous glue composition for adhering a PVA polarizing film to an alkaline-treated TAC support film according to claim 11, wherein said dicarboxylic acid monomer comprises adipic acid, glutaric acid and succinic acid.

13. The PVA-free hydrous glue composition for adhering a PVA polarizing film to an alkaline-treated TAC support film according to claim 12, wherein said dicarboxylic acid monomer has a concentration of about 1-10 wt. %.

14. The PVA-free hydrous glue composition for adhering a PVA polarizing film to an alkaline-treated TAC support film according to claim 11, wherein said protonic acid comprises hydrochloric acid, sulfuric acid and nitric acid.

15. The PVA-free hydrous glue composition for adhering a PVA polarizing film to an alkaline-treated TAC support film according to claim 14, wherein said protonic acid has a concentration of 0.1 M to 1.0 M.

16. The PVA-free hydrous glue composition for adhering a PVA polarizing film to an alkaline-treated TAC support film according to claim 11, wherein said Lewis acid comprises zinc chloride and aluminum chloride.

17. The PVA-free hydrous glue composition for adhering a PVA polarizing film to an alkaline-treated TAC support film according to claim 16, wherein said Lewis acid has a concentration of about 1-10 wt. %.

18. The PVA-free hydrous glue composition for adhering a PVA polarizing film to an alkaline-treated TAC support film according to claim 11, wherein said masking agent is dialdehyde compound.

19. The PVA-free hydrous glue composition for adhering a PVA polarizing film to an alkaline-treated TAC support film according to claim 18, wherein said dialdehyde compound comprises glyoxal and methylglyoxal.

20. The PVA-free hydrous glue composition for adhering a PVA polarizing film to an alkaline-treated TAC support film according to claim 18, wherein said masking agent has a concentration of about 3-10 wt. %.
